(19) United States
(12) Patent Application Publication
(10) Pub. No.: US 2026/0158328 A1
(43) Pub. Date: Jun. 11, 2026

(54) SPORTS LEARNING SUPPORT DEVICE, SPORTS LEARNING SUPPORT METHOD, AND PROGRAM

(71) Applicant: NIPPON TELEGRAPH AND TELEPHONE CORPORATION, Tokyo (JP)

(72) Inventors: Takemi MOCHIDA, Tokyo (JP); Takehiro FUKUDA, Tokyo (JP)

(73) Assignee: NIPPON TELEGRAPH AND TELEPHONE CORPORATION, Tokyo (JP)

(21) Appl. No.: 18/702,067

(22) PCT Filed: Oct. 19, 2021
(86) PCT No.: PCT/JP2021/038641

§ 371 Date: Apr. 17, 2024

(51) Int. Cl. A63B 24/00; A63B 71/06

(52) U.S. Cl. CPC A63B 24/0062; A63B 71/0619; A63B 2024/0068

(57) ABSTRACT

A movement learning support device includes: an upper arm angular acceleration acquisition unit configured to measure an angular acceleration of a turning movement of an upper arm; a forearm angular acceleration acquisition unit configured to measure an angular acceleration of a turning movement of a forearm; a movement correspondence sound generation unit configured to generate an upper arm movement correspondence sound which is a sound of which a feature changes in accordance with the magnitude of the angular acceleration of the turning movement of the upper arm and a forearm movement correspondence sound which is a sound of which a feature changes in accordance with the magnitude of the angular acceleration of the turning movement of the forearm; a feature adding unit configured to add different acoustic features to the generated upper arm movement correspondence sound and the generated forearm movement correspondence sound; and a sound reproduction unit configured to reproduce the upper arm movement correspondence sound to which the acoustic feature is added and the forearm movement correspondence sound to which the acoustic feature is added.

### TECHNICAL FIELD

The present invention relates to a movement learning support device, a movement learning support method, and a program that support transmission of movement skills.

### BACKGROUND ART

For learners trying to acquire new movement skills, it is generally beneficial to observe and imitate movements of skilled people who already have the skills. Furthermore, when a skilled person instructs a learner by words or gestures, transmission of the skill from the skilled person to the learner is promoted in some cases. However, the level of skill that a learner can reach can vary depending on the influence of a plurality of the following factors.
(1) The complexity and speed of the movement to be acquired
(2) The ability of the learner to understand the purpose of an instruction from a skilled person
(3) The ability of the skilled person to understand the level of the skill of the learner

In view of this, a support means aimed at reducing or overcoming difficulties associated with acquisition of movement skills has been proposed. For example, Patent Literature 1 describes a system that feeds back a timing at which the magnitude of turning movements of the bodies of learners is maximized or feeds back a deviation from an ideal timing. Such a means is useful for learners to understand their own movement states and how they differ from those of skilled people.

However, when movement skills to be acquired involve complex and fast movements with parts such as upper limbs (upper arms or forearms), such movements have a higher degree of freedom than turning movements of the trunks or the like. Therefore, it is required to extract features of the movements to be fed back more carefully and generate feedback information that is easy to understand. For example, in baseball pitching, the movements of the pitching arm just before the balls leaves contact with the fingers are very fast for a skilled person. Furthermore, in baseball pitching, skills of pitching different types of throws (straight, curve, etc.) are required. However, in a previous study (Non Patent Literature 1) in which postures of skilled people during pitching were compared between types of throws, it was reported that there is no difference in a direction of the major axis with respect to movement of the forearm, but the turning movement around the major axis was different.

### CITATION LIST

### Patent Literature

Patent Literature 1: JP 2019-97853 A

### Non Patent Literature

Non Patent Literature 1: Sakurai, S., Ikegami, Y., Okamoto, A., Yabe, K., & Toyoshima, S. (1993). “A Three-Dimensional Cinematographic Analysis of Upper Limb Movement during Fastball and Curveball Baseball Pitches.” Journal of Applied Biomechanics, 9(1), 47-65. <URL:https://doi.org/10.1123/jab.9.1.47>

### SUMMARY OF INVENTION

### Technical Problem

It is difficult for learners to accurately understand their own movements, and it is extremely difficult to appropriately show expressions when skilled person gives instructions to learners by words or gestures.

Accordingly, an object of the present invention is to provide a movement learning support device that shares a difference in movement between a skilled person and a learner and supports transmission of movement skills.

### Solution to Problem

According to an aspect of the present invention, a movement learning support device includes: an upper arm angular acceleration acquisition unit, a forearm angular acceleration acquisition unit, a movement correspondence sound generation unit, a feature adding unit, and a sound reproduction unit.

The upper arm angular acceleration acquisition unit is configured to measure an angular acceleration of a turning movement of an upper arm The forearm angular acceleration acquisition unit is configured to measure an angular acceleration of a turning movement of a forearm. The movement correspondence sound generation unit is configured to generate an upper arm movement correspondence sound which is a sound of which a feature changes in accordance with the magnitude of the angular acceleration of the turning movement of the upper arm and a forearm movement correspondence sound which is a sound of which a feature changes in accordance with the magnitude of the angular acceleration of the turning movement of the forearm. The feature adding unit is configured to add different acoustic features to the generated upper arm movement correspondence sound and the generated forearm movement correspondence sound. The sound reproduction unit is configured to reproduce the upper arm movement correspondence sound to which the acoustic feature is added and the forearm movement correspondence sound to which the acoustic feature is added.

### Advantageous Effects of Invention

The movement learning support device according to the present invention shares a difference in movement between a skilled person and a learner and supports transmission of movement skills.

### BRIEF DESCRIPTION OF DRAWINGS

FIG. 1 is a block diagram illustrating a functional configuration of a movement learning support device according to Example 1.

FIG. 2 is a first flowchart illustrating an operation of the movement learning support device according to Example 1.

FIG. 3 is a second flowchart illustrating an operation of the movement learning support device according to Example 1.

FIG. 4 is a schematic diagram illustrating a turning movement of a pitching arm (upper right arm) during pitching.

FIG. 5 is a schematic diagram illustrating a turning movement (right forearm) of the pitching arm during the pitching.

FIG. 6 is a schematic diagram illustrating an arrangement example of an acceleration sensor with respect to the upper arm.

FIG. 7 is a schematic diagram illustrating an arrangement example of an acceleration sensor with respect to the forearm.

FIG. 8 is a schematic diagram illustrating a method of measuring angular acceleration of a turning movement of the upper arm.

FIG. 9 is a schematic view illustrating a method of measuring angular acceleration of the turning movement of the forearm.

FIG. 10 is a block diagram illustrating a detailed functional configuration of a feature adding unit.

FIG. 11 is a graph illustrating time-series changes by each acceleration in the turning movement of a pitching arm.

FIG. 12 is a graph illustrating time-series changes in intensity of a feedback sound during pitching.

FIG. 13 is a graph illustrating time-series changes in a frequency component of a feedback sound during pitching.

FIG. 14 is a diagram illustrating a functional configuration example of a computer.

### DESCRIPTION OF EMBODIMENTS

Hereinafter, embodiments of the present invention will be described in detail. Constituents that have the same functions are denoted by the same reference numerals, and redundant description will be omitted.

### <Overview of Movement Learning Support Device>

A movement learning support device according to the following examples is a device that measures an angular acceleration of a turning movement around a major axis with acceleration sensors attached to an upper arm and a forearm of a pitching arm, and generates feedback information in which a feature immediately changes according to the magnitude of the angular acceleration. The movement learning support device is used by both a skilled person and a learner. It is assumed that the movement learning support devices used by the skilled person and the learner have the same configuration.

As a means for presenting the feedback information, a visual means using a light-emitting device, a tactile means using a skin excitation device, or an auditory means using a sound wave generation device is possible, and an appropriate means can be applied according to the environment in which the learner is placed.

It is known that average temporal resolutions of human vision, touch, and hearing (a lower limit of an interval at which two temporally consecutive events can be distinguished) have a relationship of vision (about 20 to 30 milliseconds)>touch (about 10 milliseconds)>hearing (about 5 milliseconds).

Therefore, in an environment suitable for listening to sound, an auditory means is most useful. However, when there is environmental noise or the like, a tactile or visual means is also expected to be useful. Here, for the tactile means, skin deformation or a proprioceptive sensation such as a sensation from a deep part of the body generated in association with physical movement of the learner and feedback information presented by the tactile means are likely to interfere with each other, and thus attention is required. For the visual means, eye movement during pitching may adversely affect pitching performance, which also requires attention. In Example 1, an example in which an auditory means is used as a presentation means will be described.

### Example 1

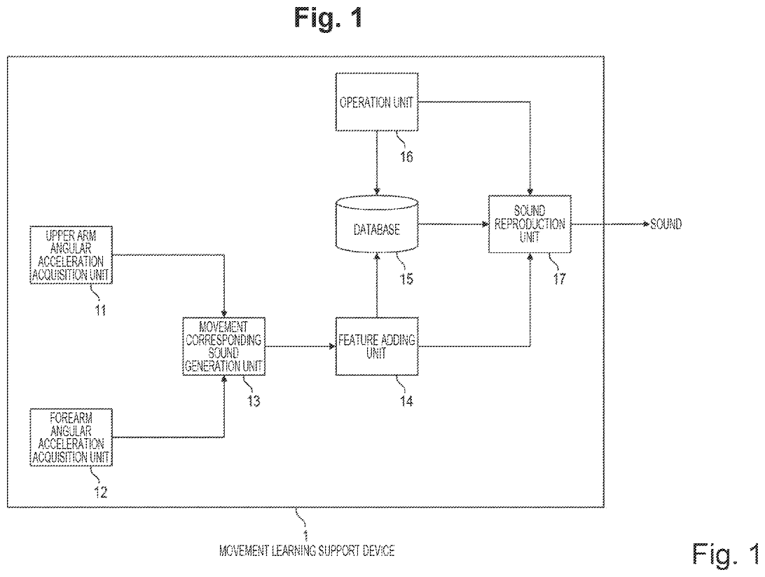

Hereinafter, a functional configuration of a movement learning support device 1 according to Example 1 will be described with reference to FIG. 1. As illustrated in FIG. 1, the movement learning support device 1 according to this example includes an upper arm angular acceleration acquisition unit 11, a forearm angular acceleration acquisition unit 12, a movement correspondence sound generation unit 13, a feature adding unit 14, a database 15, an operation unit 16, and a sound reproduction unit 17.

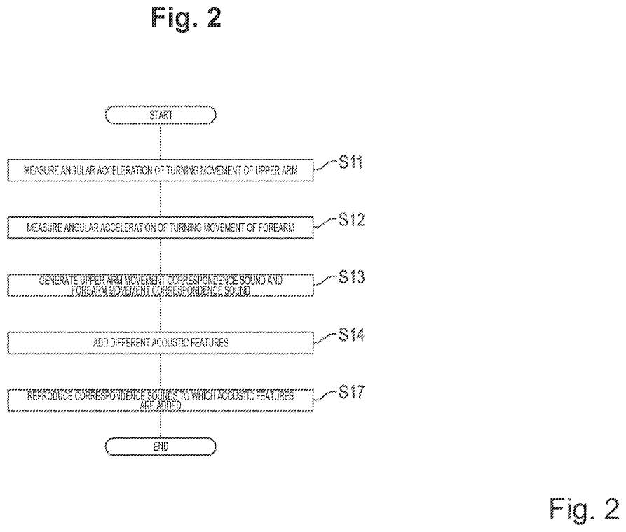

Hereinafter, a first flowchart which is a part of an operation of the movement learning support device 1 according to this example will be described with reference to FIG. 2.

The upper arm angular acceleration acquisition unit 11 includes a pair of acceleration sensors (acceleration sensors 1 and 2 to be described below) disposed at positions that are two-fold rotationally symmetric with a major axis of the upper arm as a rotation axis, and measures an angular acceleration of a turning movement of the upper arm (S11). The forearm angular acceleration acquisition unit 12 includes a pair of acceleration sensors (acceleration sensors 3 and 4 to be described below) disposed at positions that are two-fold rotationally symmetric with a major axis of the forearm as a rotation axis, and measures an angular acceleration of a turning movement of the forearm (S12). The movement correspondence sound generation unit 13 generates an upper arm movement correspondence sound of which a feature changes in accordance with the magnitude of the angular acceleration of the turning movement of the upper arm and a forearm movement correspondence sound of which a feature changes in accordance with the magnitude of the angular acceleration of the turning movement of the forearm (S13). The feature adding unit 14 adds different acoustic features to the upper arm movement correspondence sound and the forearm movement correspondence sound generated in step S13 (S14). The sound reproduction unit 17 reproduces the upper arm movement correspondence sound to which the acoustic feature is added and the forearm movement correspondence sound to which the acoustic feature is added (S17).

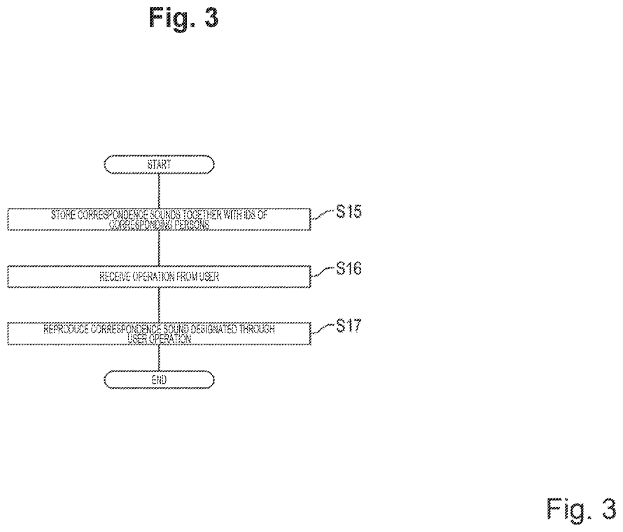

By performing the above-described steps S11 to S14 and S17, the movement learning support device 1 generates sounds corresponding to the turning movement of the upper arm and the forearm so that the sound can be heard. By hearing the upper arm movement correspondence sound and the forearm movement correspondence sound corresponding to a pitching motion of each of the skilled person and the learner, the skilled person and the learner can communicate with each other while repeating pitching which is expected to promote transmission of the skill. Further, the movement learning support device 1 may perform the second flowchart illustrated in FIG. 3 in order to support acquisition of a skill through self-study of the learner in a situation where no skilled person is present.

The database 15 stores the correspondence sounds to which the acoustic features have been added by performing steps S11 to S14 together with IDs of the corresponding persons (S15). The database 15 stores the IDs of the corresponding persons, dates and times, and the like together with the correspondence sounds. Accordingly, only the correspondence sound of the person corresponding to the skilled person can be extracted from the database 15.

The operation unit 16 receives an operation from a user (for example, a learner, a director, or the like) (S16). The movement learning support device 1 performs control in accordance with the operation input to the operation unit 16. Here, the movement learning support device 1 performs control to call and reproduce a correspondence sound (for example, a correspondence sound with an ID corresponding to the skilled person) designated by a user operation among the correspondence sounds stored in the database 15. The sound reproduction unit 17 reproduces the correspondence sound under this control (S17).

The movement learning support device 1 may reproduce the correspondence sounds stored in the database 15 as follows. The movement learning support device 1 detects the end timing of one movement operation based on the change in the values of the angular accelerations of the turning movements of the upper arm and the forearm, and performs control to reproduce any correspondence sound designated in advance (for example, the correspondence sound of the ID corresponding to the skilled person) among the correspondence sounds stored in the database 15 whenever the end timing is detected. The sound reproduction unit 17 reproduces the correspondence sound under this control (S17). Accordingly, it is possible to reproduce the upper arm movement correspondence sound and the forearm movement correspondence sound of the skilled person immediately after the upper arm movement correspondence sound and the forearm movement correspondence sound of the learner are reproduced, and it is possible to appropriately support the self-study of the learner.

Hereinafter, details of the process of each constituent will be described.

### <Upper Arm Angular Acceleration Acquisition Unit 11 and Forearm Angular Acceleration Acquisition Unit 12>

The upper arm angular acceleration acquisition unit 11 and the forearm angular acceleration acquisition unit 12 measure the angular accelerations of the turning movements of the forearm and the upper arm in accordance with the following scheme (S12).

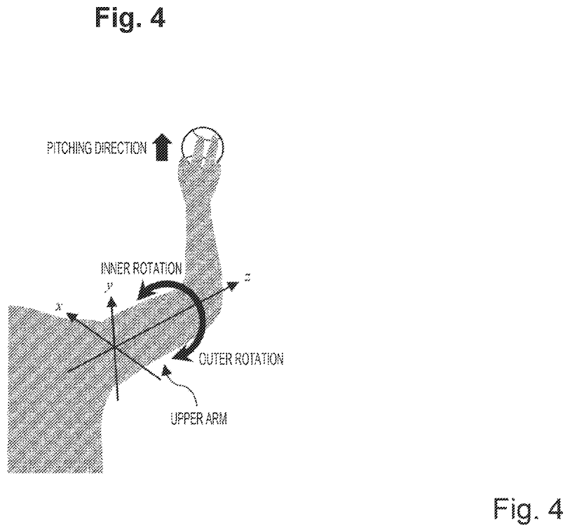

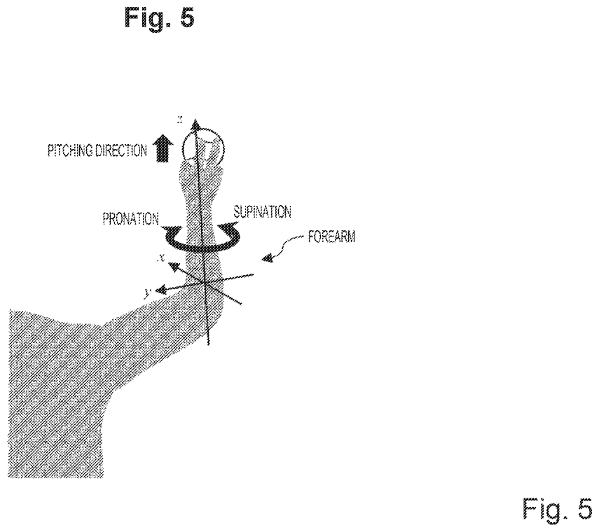

As illustrated in FIG. 4, a 3-dimensional coordinate system in which a plane perpendicular to the major axis is an x-y plane and the major axis is a z axis is defined for the upper arm. Similarly, as illustrated in FIG. 5, a 3-dimensional coordinate system in which a plane perpendicular to the major axis is an x-y plane and the major axis is a z axis is defined for the forearm. However, the origin of the x-y plane is a rotation center of a shoulder joint (in the case of the upper arm) and a rotation center of an elbow joint (in the case of the forearm).

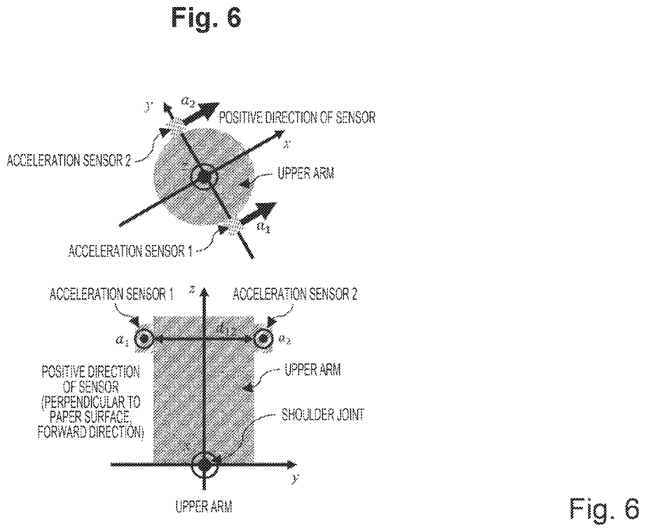

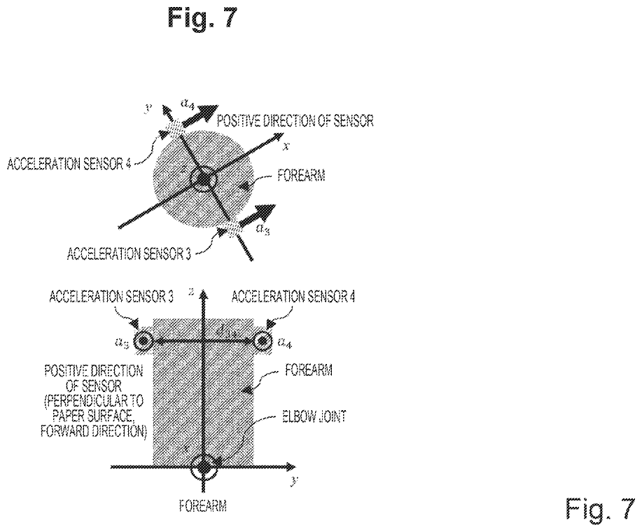

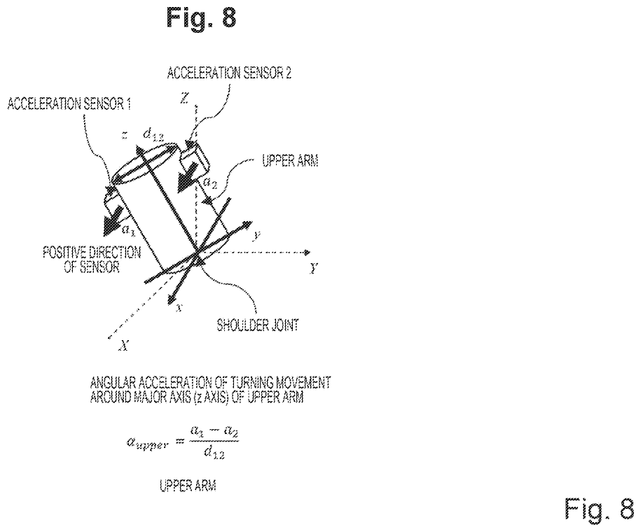

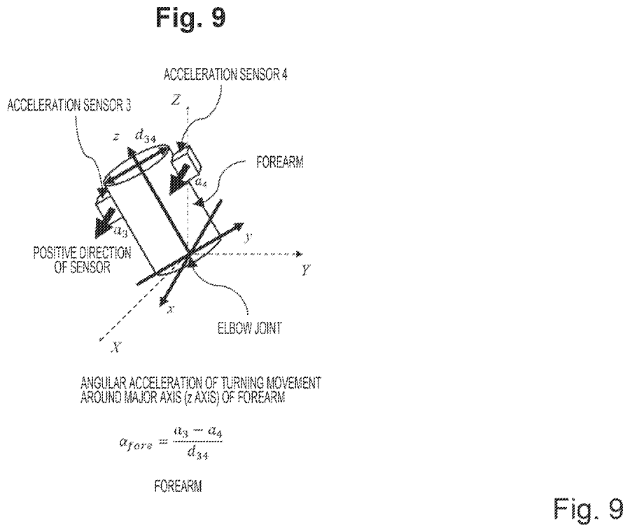

As illustrated in FIG. 6, the acceleration sensors 1 and 2 are disposed at positions that are two-fold rotationally symmetric about the z axis of the upper arm which is a rotation axis. As illustrated in FIG. 7, the acceleration sensors 3 and 4 are disposed at positions that are two-fold rotationally symmetric about the z axis of the forearm. An external fixed coordinate system common to the upper arm is defined as the XYZ axes in FIG. 8. Similarly, an external fixed coordinate system common to the forearm is defined as the XYZ axes in FIG. 9.

Values detected by the acceleration sensors 1 and 2 are a₁ and a₂, respectively. a₁ and a₂ include a component by gravity, a component by a translational movement of the upper arm, a component by a turning movement of the upper arm around the shoulder joint, and a component by a turning movement around the major axis of the upper arm. Of these components, positiveness and negativeness of the component by the turning movement are reversed in the acceleration sensors 1 and 2, and the other components have the same value in the two sensors. Accordingly, when a difference between a₁ and a₂ is divided by 2, a tangential acceleration of the turning movement of the upper arm is obtained.

Further, when a distance between the acceleration sensors 1 and 2 is d₁₂, a radius of the turning movement of each sensor is d₁₂/2. Accordingly, when an angular acceleration of the turning movement of the upper arm around the z axis is set to αᵤₚₚₑᵣ, αᵤₚₚₑᵣ=(a₁−a₂)/2÷d₁₂/2=(a₁−a₂)/d₁₂ can be expressed.

Similarly, when the values detected by the acceleration sensors 3 and 4 are a₃ and a₄, respectively, the distance between the acceleration sensors 3 and 4 is d₃₄, and the angular acceleration of the turning movement of the forearm around the z axis is α_{fore}, α_{fore}=(a₃−a₄)/d₃₄ can be expressed. A method of measuring the angular acceleration of the turning movement using the pair of acceleration sensors as described above is a technique of the related art. As a method of measuring the angular acceleration of the turning movement, for example, Reference Non Patent Literature 1 is disclosed.
(Reference Non Patent Literature 1: Saito, Watanabe, Inoue, Inoue, Sakai, and Takeda, Yakyu tokyu ni okeru joshi taikan undo no kansei sensa keisoku (Inertial sensor measurement of upper limb and trunk movements in baseball pitching), Journals of Nagoya Gakuin University, Humanities and Natural Sciences, Vol. 48, No. 1, pp. 33-48, 2011)

The upper arm angular acceleration acquisition unit 11 and the forearm angular acceleration acquisition unit 12 acquire the angular acceleration of the turning movement of each of the upper arm and the forearm in a sampling period T by the foregoing scheme. However, T is set to satisfy 2F<1/T with respect to a highest frequency F that can be generated in the angular acceleration.

### <Movement Correspondence Sound Generation Unit 13>

The movement correspondence sound generation unit 13 generates the upper arm movement correspondence sound and the forearm movement correspondence sound by the following scheme (S13).

A value of the angular acceleration acquired at time iT (where i is an integer of zero or more) is α₁, and a sound source of which a feature changes in accordance with the value is xᵢ(t) (where iT≤t<(i+1)T). Various types of signals can be used as the sound source xᵢ(t). For example, when sawtooth waves are used, the sawtooth waves are defined as follows.

$${x}_{i} ( t ) = p ( {α}_{i} ) {\sum }_{k = 1}^{M} \frac{sin ( 2 π kf ( {α}_{i} ) t + {ϕ}_{k} ( iT ) )}{k} iT \leq t \leq ( i + 1 ) T \qquad [ Math . 1 ]$$

Note that p(αᵢ) represents amplitude of a first order overtone (base tone), f(αᵢ) represents a frequency of the first order overtone (base tone), φₖ(iT) represents an initial phase of a k-th order overtone, and M represents an order of the highest order overtone.

The amplitude p and the fundamental frequency f of the sawtooth waves may be a monotonically increasing function of the absolute value of the angular acceleration α. For example, as the function p(α), the monotonically increasing function of |α| such as p(α)∝|α|, p(α)∝e^{|α|}, and p(α)∝log|α| can be used. As an example of the function f(a), a monotonically increasing function of |α| such as f(α)∝|α|, f(α)∝e^{|α|}, and f(α)∝log|α| can be used.

p(α) and f(α) may be the same function or different functions. The initial phase φₖ(iT) of the kth-order overtone is appropriately used to reduce a discontinuous change in the phase of each overtone that may occur when the sampling time iT of the angular acceleration is updated.

As the type of sound source, not only sawtooth waves but a periodic composite sound such as triangular waves or rectangular waves may also be used, and the amplitude and frequency may be modulated by a function of acceleration. Alternatively, aperiodic noise may be used to modulate the amplitude by the function of acceleration.

### <Feature Adding Unit 14>

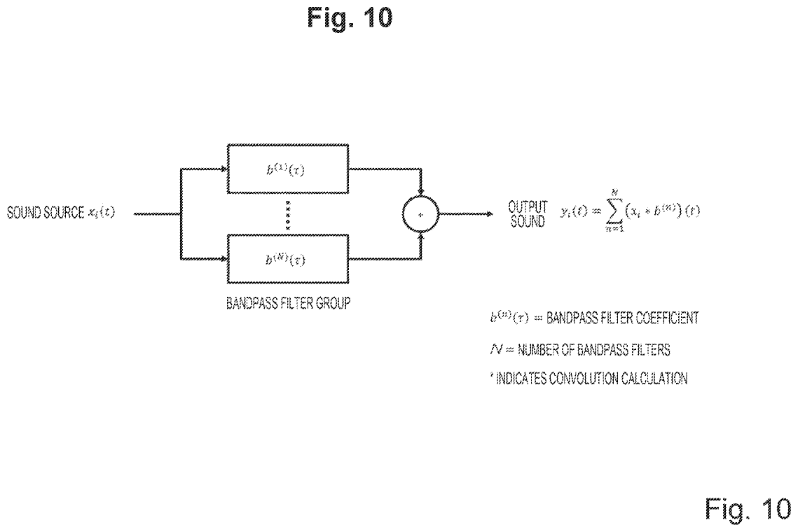

The feature adding unit 14 applies a time-invariant parallel bandpass filter group to the upper arm movement correspondence sound and the forearm movement correspondence sound generated by the foregoing scheme, and applies a static feature to the tone of each sound source (S14). FIG. 10 illustrates a configuration example of the feature adding unit 14.

Here, the number N of bandpass filters forming the bandpass filter group may be any number. For example, when N=2, the power spectrum of the output sound y₁(t) output from the filter group can have two peak frequencies. Generally, when a sound with two peak frequencies in the power spectrum is heard, two peak frequencies are combined to result in perception of vowel sounds (A, I, U, E, O).

Accordingly, the feature adding unit 14 may perform the bandpass filter process on the upper arm movement correspondence sound and the forearm movement correspondence sound so that two different peak frequencies are combined for the power spectra of the upper arm movement correspondence sound and the forearm movement correspondence sound. Accordingly, it is easy to understand the turning movement of each of the upper arm and the forearm.

The types of sound sources (sawtooth waves, triangular waves, rectangular waves, noise, or the like) for the upper arm and the forearm may be the same or different. Further, when the types of sound sources for the upper arm and the forearm are different, the bandpass filter groups for the upper arm and the forearm may have the same setting.

<Advantageous Effects Brought about by Movement Learning Support Device 1 in Example 1>

The skilled person and the learner can compare the feedback information immediately generated with each pitching with each other and share information regarding how the movements of both the skilled person and the learner are different. As a result, the learner can easily understand a purpose of an instruction of the skilled person, and the skilled person can easily understand a skill level of the learner. Even in a situation where the skilled person and the learner cannot communicate with each other, the learner can immediately receive the feedback information regarding the skilled person stored in advance. The learner imitates the feedback information immediately generated as the learner pitches a ball while comparing the feedback information with the feedback of the skilled person, so that the acquisition of the skill is promoted by self-study.

### <Actual Data>

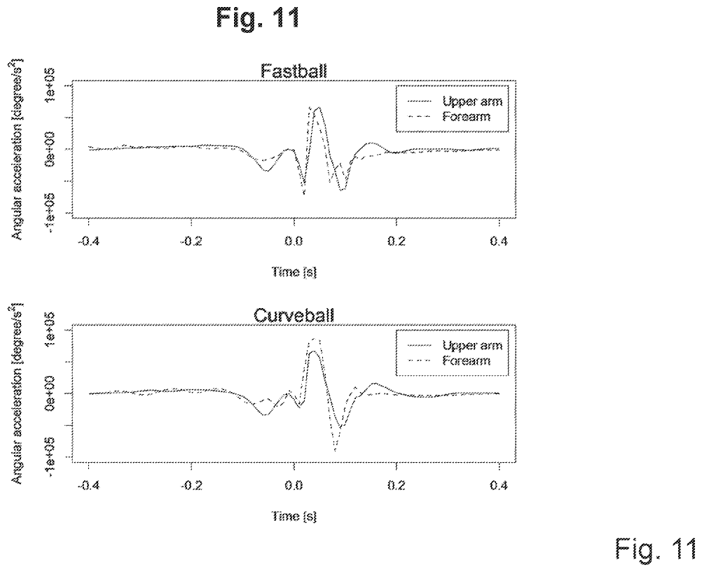

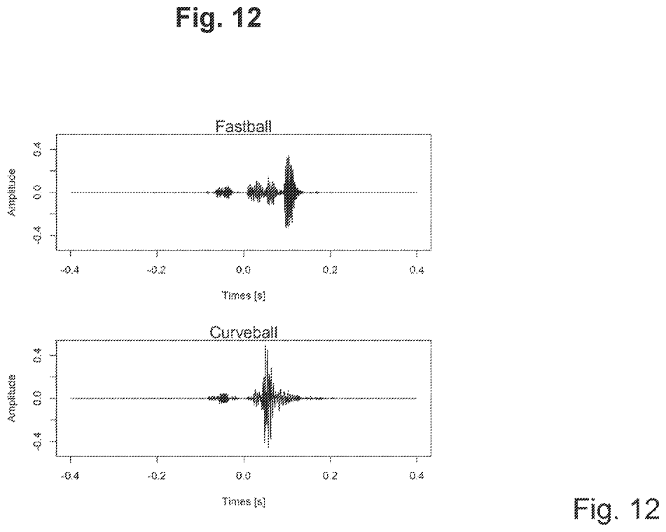

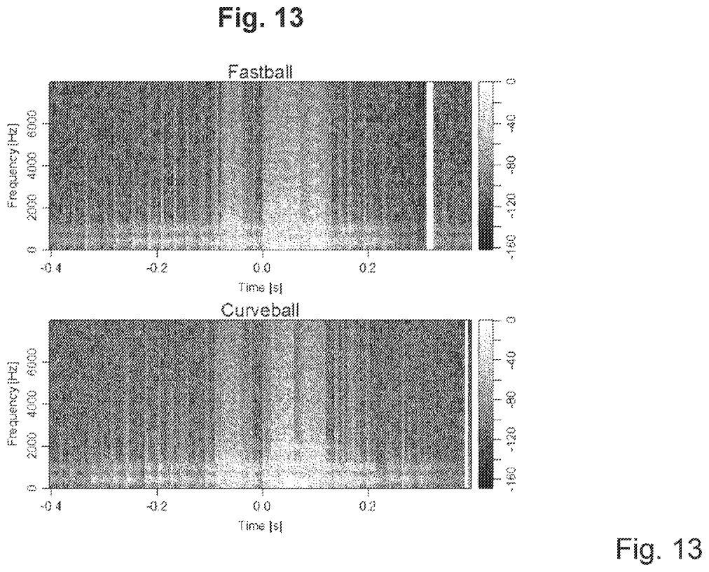

FIG. 11 illustrates angular accelerations of turning movements of the upper arm and the forearm of the throwing arm when the skilled person throws two types of balls (fastball and curveball) one by one. A feedback sound signal and a spectrogram of the feedback sound signal immediately generated using the movement learning support device 1 during pitching are illustrated in FIGS. 12 and 13. In FIGS. 11 to 13, time 0 on the time axis represents a moment when a ball is released from a hand. In the curve of FIG. 11, a solid line indicates the angular acceleration of the upper arm, and a broken line indicates the angular acceleration of the forearm. When the graph of the fastball is compared with the graph of the curveball in FIG. 11, the temporal change of the angular acceleration of the upper arm is relatively similar, but the temporal change of the angular acceleration of the forearm is large. Features of the different movements are reflected in a difference in acoustic features of the feedback sounds seen in FIGS. 12 and 13.

In FIG. 11, it can be understood that the absolute value of each angular acceleration generates a very sharp peak only once immediately after the ball is released from the hand. By using this property, it is possible to determine whether one pitching trial has ended by comparison with a threshold, and to implement the above-described process of “detecting an end timing of one movement operation based on changes in values of the angular accelerations of the turning movements of upper arm and the forearm”.

### <Supplement>

The device according to the present invention includes, for example, an input unit that can be connected to a keyboard or the like as a single hardware entity, an output unit that can be connected to a liquid crystal display or the like, a communication unit that can be connected to a communication device (e.g., a communication cable) capable of communicating with the outside of the hardware entity, a central processing unit (CPU which may include a cache memory or a register), a RAM or a ROM which is a memory, an external storage device as a hard disk, and a bus that connects the input unit, the output unit, the communication unit, the CPU, the RAM, the ROM, and the external storage device so that data can be exchanged therebetween. A device (drive) or the like that can write and read data in and from a recording medium such as a CD-ROM may be provided in the hardware entity as necessary. Examples of a physical entity including such a hardware resource include a general-purpose computer.

The external storage device of the hardware entity stores a program required to implement the above-described functions, data required to process the program, and the like (the present invention is not limited to the external storage device and the program may be stored, for example, in a ROM which is a read-only storage device). Data or the like obtained by processing the program is appropriately stored in a RAM, an external storage device, or the like.

In the hardware entity, each program stored in the external storage device (or ROM or the like) and data required to process each program are read to a memory as necessary and are appropriately interpreted and processed by the CPU. As a result, the CPU implements a predetermined function (each component represented as . . . unit, . . . means, or the like).

The present invention is not limited to the above-described embodiment and can be appropriately modified without departing from the gist of the present invention. The processes described in the foregoing embodiment may be executed not only chronologically in accordance with the described order, but also in parallel or individually in accordance with the processing capability of a device that executes the processes or as necessary.

As described above, when the processing function of the hardware entity (the device according to the present invention) described in the foregoing embodiment is implemented by a computer, processing content of the function of the hardware entity is described by a program. In addition, as the computer executes the program, the processing function of the hardware entity is implemented on the computer.

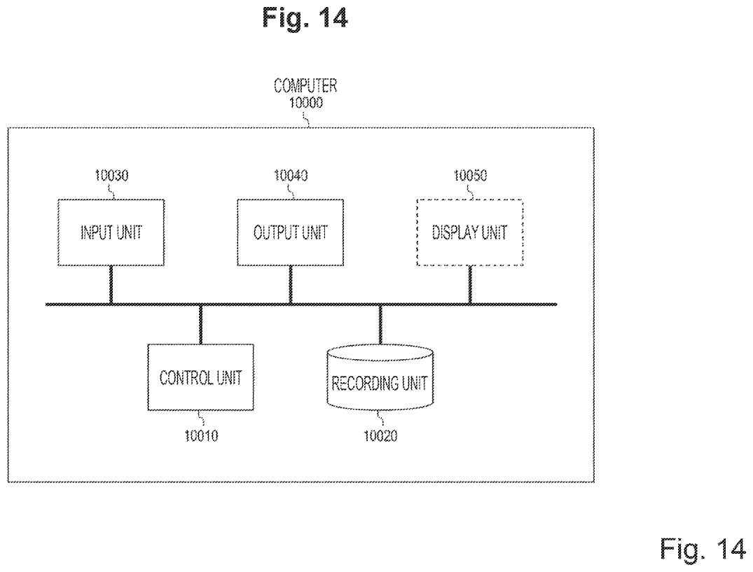

The above-described various processes can be performed by causing a recording unit 10020 of a computer 10000 illustrated in FIG. 14 to read a program for executing each step of the foregoing method and causing a control unit 10010, an input unit 10030, an output unit 10040, and the like to operate.

The program in which the processing details are written may be recorded on a computer-readable recording medium. The computer-readable recording medium may be, for example, any recording medium such as a magnetic recording device, an optical disc, a magneto-optical recording medium, or a semiconductor memory. Specifically, for example, a hard disk device, a flexible disk, a magnetic tape, or the like can be used as the magnetic recording device, a digital versatile disc (DVD), a DVD random access memory (DVD-RAM), a compact disc read only memory (CD-ROM), a CD recordable/rewritable (CD-R/RW), or the like can be used as the optical disc, a magneto-optical disc (MO) or the like can be used as the magneto-optical recording medium, and an electrically erasable and programmable-read only memory (EEP-ROM) or the like can be used as the semiconductor memory.

The program is distributed by, for example, selling, transferring, or renting a portable recording medium such as a DVD or a CD-ROM in which the program is recorded. Further, a configuration in which the program is stored in a storage device of a server computer and the program is distributed by transferring the program from the server computer to other computers via a network may also be employed.

For example, a computer that executes such a program first temporarily stores a program recorded in a portable recording medium or a program transferred from the server computer in a storage device of the own computer. Then, when a process is performed, the computer reads a program stored in the recording medium of the own computer and executes the process according to the read program. As another execution mode of the program, the computer may read the program directly from a portable recording medium and perform a process in accordance with the program, or alternatively, the computer may sequentially perform a process in accordance with a received program whenever the program is transferred from a server computer to the computer. The above-described processes may be performed by a so-called application service provider (ASP) type service that implements a processing function only by an execution instruction and result acquisition without transferring the program from the server computer to the computer. The program in this mode includes information that is to be used in a process by an electronic computer and is equivalent to the program (data and the like that are not direct commands to the computer but have properties that define the process to be performed by the computer).

Although the hardware entity is configured by causing a computer to execute a predetermined program in the present embodiment, at least some of the processing content may be implemented by hardware.

1. A movement learning support system comprising:
at least one processor; and
memory storing instructions that, when executed by the at least one processor, causes the system to perform a set of operations, the set of operations comprising:
measuring an angular acceleration of a turning movement of an upper arm;
measuring an angular acceleration of a turning movement of a forearm;
generating an upper arm movement correspondence sound which is a sound of which a feature changes in accordance with the magnitude of the angular acceleration of the turning movement of the upper arm and a forearm movement correspondence sound which is a sound of which a feature changes in accordance with the magnitude of the angular acceleration of the turning movement of the forearm;
adding different acoustic features to the generated upper arm movement correspondence sound and the generated forearm movement correspondence sound; and
reproducing the upper arm movement correspondence sound to which the acoustic feature is added and the forearm movement correspondence sound to which the acoustic feature is added.

2. The movement learning support system according to claim 1, further comprising:
storing the correspondence sounds to which the acoustic features are added together with an ID of a corresponding person; and
receiving an operation from a user,
wherein a correspondence sound is reproduced and is designated through an operation from the user among the correspondence sounds stored in the database.

3. The movement learning support system according to claim 1, wherein an end timing of one movement operation is detected based on a change in values of the angular accelerations of the turning movements of the upper arm and the forearm;
wherein one predesignated correspondence sound is reproduced among the correspondence sounds stored in the database whenever the end timing is detected.

4. The movement learning support device according to claim 1, wherein the feature adding unit performs a bandpass filter process is performed on the upper arm movement correspondence sound and the forearm movement correspondence sound so that two different peak frequencies are combined for power spectra of the upper arm movement correspondence sound and the forearm movement correspondence sound.

5. A movement learning support method comprising:
measuring an angular acceleration of a turning movement of an upper arm;
measuring an angular acceleration of a turning movement of a forearm;
generating an upper arm movement correspondence sound which is a sound of which a feature changes in accordance with the magnitude of the angular acceleration of the turning movement of the upper arm and a forearm movement correspondence sound which is a sound of which a feature changes in accordance with the magnitude of the angular acceleration of the turning movement of the forearm;
adding different acoustic features to the generated upper arm movement correspondence sound and the generated forearm movement correspondence sound; and
reproducing the upper arm movement correspondence sound to which the acoustic feature is added and the forearm movement correspondence sound to which the acoustic feature is added.

6. (canceled)

7. A computer-readable non-transitory recording medium storing computer-executable program instructions that when executed by a processor cause a computer to execute a program generation method comprising:
measuring an angular acceleration of a turning movement of an upper arm;
measuring an angular acceleration of a turning movement of a forearm;
generating an upper arm movement correspondence sound which is a sound of which a feature changes in accordance with the magnitude of the angular acceleration of the turning movement of the upper arm and a forearm movement correspondence sound which is a sound of which a feature changes in accordance with the magnitude of the angular acceleration of the turning movement of the forearm;
adding different acoustic features to the generated upper arm movement correspondence sound and the generated forearm movement correspondence sound; and
reproducing the upper arm movement correspondence sound to which the acoustic feature is added and the forearm movement correspondence sound to which the acoustic feature is added.

8. The movement learning support system according to claim 2, wherein an identification of the user determines the reproduced corresponding sound.

9. The movement learning support system according to claim 1, wherein a plurality of acceleration sensors is arranged at positions having two-fold symmetry based on a rotation of the forearm.
